(19) United States
(12) Patent Application Publication
(10) Pub. No.: US 2005/0114109 A1
(43) Pub. Date: May 26, 2005

(54) STRUCTURE OF INTEGRIN ALPHA V-beta 3 EXTRACELLULAR DOMAIN COMPLEXED WITH LIGAND

(76) Inventor: M. Amin Arnaout, Chestnut Hill, MA (US)

Correspondence Address: FISH & RICHARDSON PC, 225 FRANKLIN ST, BOSTON, MA, 02110, US

(21) Appl. No.: 10/503,960

(22) PCT Filed: Feb. 7, 2003
(86) PCT No.: PCT/US03/03903

Related U.S. Application Data
(60) Provisional application No. 60/354,773, filed on Feb. 7, 2002.

(51) Int. Cl. G06G 7/48; G06G 7/58

(52) U.S. Cl. 703/11

(57) ABSTRACT

The present invention relates to structure-based methods for identifying molecules which will bind to the αA-lacking integrin αVβ3 receptor extracellular domain and modulate function, e.g., by acting as receptor agonists, such as agonists that induce some or all of the biological responses induced by the ligand Arg-Gly-Asp-(D-Phe)-(N-methyl-Val), although the methods are not limited to the identification of this particular class of agonist. The invention also provides a computer for producing a three-dimensional representation of a molecule or molecular complex, wherein said molecule or molecular complex comprises a binding pocket defined by structure coordinates of Table 1 or Table 2. In addition, the invention provides a crystal comprising an integrin IVJ3 extracellular domain alone or complexed with a cyclic RGD peptide as defined by the structural coordinates of Table 1 or Table 2.

### STATEMENT REGARDING GOVERNMENT SPONSORED RESEARCH

This research was supported by grants from the National Institutes of Health (NIDDK, NHLBI and NIAID) and in part by the U.S. Department of Energy, Office of Biological and Environmental Research, under contract W-31-109-Eng-38.

### REFERENCE TO TABLES SUBMITTED ON A COMPACT DISC

This application includes a compact disc (submitted in duplicate) containing Table 1 and Table 2. The tables are identified on the compact disc as follows.

| File Name | Date of Creation | Size (bytes) |
|---|---|---|
| Table 1 | Feb. 6, 2002 | 828 kB |
| Table 2 | Feb. 6, 2002 | 831 kB |

The entire content of each of these files is hereby incorporated by reference.

### BACKGROUND

Integrins are adhesion receptors that mediate vital bi-directional signals during morphogenesis, tissue remodeling and repair (reviewed in M. J. Humphries, Biochem Soc Trans 28, 311-39 (2000)). Integrins are heterodimers formed by noncovalent association of an α and a β subunit, both type I membrane proteins with large. extracellular segments. In mammals, eighteen α and eight β subunits assemble into 24 different receptors. Integrins depend on divalent-cations to bind their extracellular ligands. Although these ligands are structurally diverse, they all employ an acidic residue during integrin recognition. Specificity for a particular ligand is then determined by additional contacts with the integrin. High affinity binding of integrins to ligands is usually not constitutive, but is elicited in response to cell “activation” signals (so-called “inside-out’ signaling) that alter the tertiary and quaternary structure of the extracellular region, making the integrin ligand-competent. Ligand binding in turn induces structural rearrangements in integrins that trigger “outside-in” signaling (reviewed in E. F. Plow, T. A. Haas, L. Zhang, J. Loftus, J. W. Smith, J Biol Chem 275, 21785-8. (2000)).

Integrins can be grouped into two classes based on the presence or absence of a ˜180 amino acid A-type domain (αA or I domain; see M. Michishita, V. Videm, M. A. Arnaout, Cell 72, 857-867 (1993)). In the nine αA-containing integrins (αA-integrins), αA is the major ligand binding site. Thus, isolated αA binds directly and in a divalent-cation-dependent manner to physiologic ligands with affinity equal to that of the respective ligand-competent heterodimer (Michishita et al., supra). The structures of isolated αA domains in “liganded” (high-affinity) and “unliganded” (low-affinity) conformations (J.-O. Lee, P. Rieu, M. A. Arnaout, R. Liddington, Cell 80, 631-638. (1995); J. P. Xiong, R. Li, M. Essafi, T. Stehle, M. A. Arnaout, J Biol Chem 275, 38762-7. (2000)) have revealed how this domain interacts with ligands. A metal ion is coordinated at the ligand-binding interface of αA through a conserved five amino acid motif, the metal-ion-dependent-adhesion-site (MIDASF), and the metal coordination is completed by a glutamate from the ligand (Lee et al., supra; J. Emsley, C. G. Knight, R. W. Famdale, M. J. Bames, R. C. Liddington, Cell 100, 47-56 (2000)) or, in its absence, by a water molecule (J.-O. Lee, L. Anne-Bankston, M. A. Amaout, R. C. Liddington, Structure 3, 1333-1340 (1995)). In αA-lacking integrins, such as the αVβ3 integrin, it has been proposed that ligand recognition is supported by an αA-like domain (αA) present in all integrin β subunits (Lee et al., supra). The a subunit is believed to participate in ligand recognition but the precise location of its ligand binding site is not known (reviewed in Humphries, supra).

### SUMMARY

The invention features methods for identifying molecules which will bind to the αA-lacking integrin αVβ3 receptor extracellular domain and modulate function, e.g., by acting as receptor agonists, such as agonists that induce some or all of the biological responses induced by the ligand Arg-Gly-Asp-(D-Phe)-(N-methyl-Val), although the methods are not limited to the identification of this particular class of agonist. The structural information described herein can also be used to identify various agonists and inhibitors of αVβ3 activity. Preferred mimetics and agonists identified using the method of the invention act as agonists in one or more in vitro or in vivo biological assays of the activity of a natural ligand of αVβ3 receptor activity.

The methods of the invention entail identification of compounds having a particular structure. The methods rely on the use of precise structural information derived from x-ray crystallographic studies of the extracellular domain of αVβ3 receptor complexed with a representative peptide ligand. This crystallographic data permit the identification of atoms in the peptide ligand mimetic that are important for receptor binding and activation. More importantly, these data define a three dimensional array of the important contact atoms. Other molecules which include a portion in which the atoms have a similar three dimensional arrangement similar to some or all of these contact atoms are likely to be capable of acting as a receptor ligand.

In one aspect, the invention provides a method for determining whether a test compound is a potential modulator of αVβ3 integrin, the method comprising:
a) providing a computer model of the three-dimensional structure comprising a binding site of αVβ3 integrin defined by the atomic coordinates of αVβ3 integrin amino acids αV:Ala215, αV:Asp218; αV:Asp150; αV:Tyr178; β3:Tyr122; β3:Arg214; β3:Asn215; and ⊖3:Arg216 according to Table 2;
b) providing a computer model of the three dimensional structure of a test compound;
c) computationally performing a fitting operation between the computer model of the binding site and the computer model of the test compound; and
d) evaluating the results of the fitting operation to evaluate the ability of the test compound to bind αVβ3 integrin;
   wherein a test compound having the ability to bind αVβ3 integrin is a potential modulator of αVβ3 integrin.

In some embodiments, the computer model of the three-dimensional structure of a test compound is from a database of compounds of known structure. In some embodiments, the three-dimensional structure of the binding site of αVβ3 integrin is defined by the atomic coordinates of αVβ3 integrin amino acids according to Table 2. In some embodiments, the fitting operation comprises determining an energy minima configuration of computer model of the three-dimensional structure of the test compound in the computer model of the three-dimensional structure of αVβ3 integrin. In some embodiments, the test compound is: (i) computationally assembled molecular fragments; (ii) selected from a small molecule database; or (iii) computationally created by de novo ligand design.

In a second aspect, the invention provides a method for determining whether a test compound is a potential modulator of αVβ3 integrin, the method comprising:
a) providing a computer model of the three-dimensional structure comprising a binding site of αVβ3 integrin defined by the atomic coordinates of αVβ3 integrin amino acids αV:Ala215, αV:Asp218; αV:Asp150; αV:Tyr178; β3:Asp119; β3:Ser121; β3:Tyr122; β3:Ser123; β3:Asp126; β3:Asp127; β3:Asp58; β3:Arg214; β3:Asn215; β3:Arg216; β3:Asp217; β3:Ala218; β3:Pro219; β3:Glu220; and β3:Asp251 according to Table 2;
b) providing a computer model of the three dimensional structure of a test compound;
c) computationally performing a fitting operation between the computer model of the binding site and the computer model of the test compound; and
d) evaluating the results of the fitting operation to evaluate the ability of the test compound to bind αVβ3 integrin;
   wherein a test compound having the ability to bind αVβ3 integrin is a potential modulator of αVβ3 integrin.

In some embodiments, the computer model of the three-dimensional structure of a binding site of αVβ3 is further defined by the inclusion of the atomic coordinates of one or more divalent cations according to Table 2. In some embodiments,.the computer model of the three-dimensional structure of a test compound is from a database of compounds of known structure. In some embodiments, the three-dimensional structure of the binding site of αVβ3 integrin is defined by the atomic coordinates of αVβ3 integrin amino acids according to Table 2. In some embodiments, the fitting operation comprises determining an energy minima configuration of computer model of the three-dimensional structure of the test compound in the computer model of the three-dimensional structure of αVβ3.

In a third aspect, the invention provides a method for determining whether a test compound is a potential modulator of αVβ3 integrin, the method comprising:
a) providing a computer model of the three-dimensional structure comprising a binding site of αVβ3 defined by the atomic coordinates of αVβ3 amino acids αV:Ala215, αV:Asp218; αV:Asp150; αV:Tyr178; β3:Asp119; β3:Ser121; β3:Tyr122; β3:Ser123; β3:Asp126; β3:Asp127; β3:Asp158; β3:Arg214; β3:Asn215; β3:Arg216; β3:Asp217; β3:Ala218; β3:Pro219; β3:Glu220; and β3:Asp251 according to Table 2;
b) providing a computer model of the three dimensional structure of a test compound;
c) computationally performing a fitting operation between the computer model of the binding site and the computer model of the test compound;
d) evaluating the results of the fitting operation to evaluate the ability of the test compound to bind αVβ3 integrin;
e) electing a test compound having the ability to bind αVβ3 integrin as a potential modulator of αVβ3 integrin;
f) obtaining or synthesizing the potential modulator; and
g) evaluating the ability of the potential modulator to modulate the activity of αVβ3 integrin.

In some embodiments, the computer model of the three-dimensional structure of a binding site of αVβ3 integrin is further defined by the inclusion of the atomic coordinates of one or more divalent cations according to Table 2. In some embodiments, the fitting operation comprises determining an energy minima configuration of computer model of the three-dimensional structure of the test compound in the computer model of the three-dimensional structure of αVβ3 integrin. In some embodiments, the evaluating comprises determining the binding affinity of the test compound for βVβ3 integrin.

In a fourth aspect, the invention provides a method for determining whether a test compound is a potential modulator of αVβ3 integrin, the method comprising:
a) providing a computer model of the three-dimensional structure of cyclo(RGDf-N-Me-V) according to Table 1 or Table 2;
b) providing a computer model of the three dimensional structure of a test compound;
c) computationally comparing the computer model of the binding site and the computer model of the test compound; and
d) evaluating the results of the comparison to evaluate the ability of the test compound to bind αVβ3 integrin;
   wherein a test compound having a structure similar to cyclo(RGDf-N-Me-V) is a potential modulator of αVβ3 integrin.

In a fifth aspect, the invention provides a method for determining whether a test compound is a potential modulator of αVβ3 integrin, the method comprising:
a) providing a computer model of the three-dimensional structure comprising an active site groove of αVβ3 integrin defined by the atomic coordinates of αVβ3 integrin amino acids αV:Ala215, αV:Asp218; αV:Asp150; αV:Tyr178; β3:Tyr122; β3: Arg214; β3:Asn215; and β3:Arg216 according to Table 2;
b) providing a computer model of the three dimensional structure of a test compound;
c) computationally performing a fitting operation between the computer model of the active site groove and the computer model of the test compound; and
d) evaluating the results of the fitting operation to evaluate the ability of the test compound to interact with the active site groove of αVβ3 integrin;
   wherein a test compound having the ability to interact with the active site groove of αVβ3 integrin is a potential modulator of αVβ3 integrin.

In some embodiments, the computer model of the three-dimensional structure of a test compound is from a database of compounds of known structure. In some embodiments, the three-dimensional structure of the active site groove of αVβ3 integrin is defined by the atomic coordinates of αVβ3 integrin amino acids according to Table 2. In some embodiments, the fitting operation comprises determining an energy minima configuration of computer model of the three-dimensional structure of the test compound in the computer model of the three-dimensional structure of αVβ3 integrin. In some embodiments, the active site groove is formed by the D3-A3, A3-B3, and D4-A4 loops (as shown in FIG. 2A).

In a sixth aspect, the invention provides a method for evaluating the potential of a chemical entity to associate with:
a) a molecule or molecular complex comprising a binding pocket defined by the atomic coordinates of aαVβ3 integrin amino acids αV:Ala215, αV:Asp218; αV:Asp150; αV:Tyr178; β3:Tyr122; β3:Arg214; β3:Asn215; and β3:Arg216 according to Table 2, or
b) a homologue of the molecule or molecular complex, wherein the homologue comprises a binding pocket that has a root mean square deviation from the backbone atoms of the amino acids of not more than 1.5 Å, the method comprising:
   i) employing computational means to perform a fitting operation between the chemical entity and a binding pocket defined by the structure coordinates of αVβ3 integrin amino acids αV:Ala215, αV:Asp218; αV:Asp150; αV:Tyr178; β3:Tyr122; β3: Arg214; β3:Asn215; and β3:Arg216 according to Table 2 ±a root mean square deviation from the backbone of the amino acids of not more than 1.5 Å; and
   ii) analyzing the results of the fitting operation to quantify the association between the chemical entity and the binding pocket.

In some embodiments, the method evaluates the potential of a chemical entity to associate with:
a) a molecule or molecular complex comprising a binding pocket defined by the atomic coordinates of αVβ3 integrin amino acids αV:Ala215, αV:Asp218; αV:Asp150; αV:Tyr178; β3:Asp119; β3:Ser121; β3:Tyr122; β3:Ser123; β3:Asp126; β3:Asp127; β3:Asp158; β3:Arg214; β3:Asn215; β3:Arg216; β3:Asp217; β3:Ala218; β3:Pro219; β3:Glu220; and β3:Asp251 according to Table 2, or
b) a homologue of the molecule or molecular complex, wherein the homologue comprises a binding pocket that has a root mean square deviation from the backbone atoms of the amino acids of not more than 1.5 Å.

In a seventh aspect, the invention provides a method for identifying a potential modulator of molecule or molecular complex comprising αVβ3 integrin-like binding pocket, the method comprising:
a) using the atomic coordinates of αVβ3 integrin amino acids αV:Ala215, αV:Asp218; αV:Asp150; αV:Tyr178; β3:Tyr122; β3:Arg214; β3:Asn215; and β3:Arg216 according to Table 2 ±a root mean square deviation from the backbone atoms of the amino acids of not more than 1.5 Å, to generate a three-dimensional structural model of a molecule or molecular complex comprising an βVβ3 integrin-like binding pocket;
b) employing the three-dimensional structural model to design or select said potential modulator;
c) synthesizing the potential modulator; and
d) contacting the potential modulator with the molecule or molecular complex to determine the ability of the potential modulator to interact with the molecule or molecular complex.

In an eighth aspect, the invention provides a method for evaluating the potential of a chemical entity to associate with a molecule or molecular complex comprising a ligand binding pocket of an αVβ3 extracellular domain, the method comprising:
a) employing computational means to perform a fitting operation between the chemical entity and a binding pocket defined by the structural coordinates described in Table 1 or Table 2; and
b) analyzing the results of said fitting operation to quantify the association between the chemical entity and the binding pocket.

In a ninth aspect, the invention provides a computer for producing a three-dimensional representation of a molecule or molecular complex, wherein said molecule or molecular complex comprises a binding pocket defined by structure coordinates of Table 1 or Table 2 wherein said computer comprises:
a) a machine-readable data storage medium comprising a data storage material encoded with machine-readable data, wherein said data comprises the structure coordinates of Table 1 or Table 2 amino acids of the αVβ3 extracellular domain;
b) a working memory for storing instructions for processing said machine-readable data;
c) a central-processing unit coupled to said working memory and to said machine-readable data storage medium for processing said machine readable data into said three-dimensional representation; and
d) a display coupled to said central-processing unit for displaying said three-dimensional representation.

In a tenth aspect, the invention provides a crystal comprising an integrin αVβ3 extracellular domain complexed with a cyclic RGD peptide. In some embodiments, the cyclic RGD peptide ligand comprises an amino acid sequence comprising Arg-Gly-Asp-(D-Phe)-(N-methyl-Val). In some embodiments, the cyclic RGD peptide ligand comprises an amino acid sequence comprising Arg-Gly-Asp-(D-Phe)-(N-methyl-Val) in the presence of a metal.

Definitions

As used herein, “integrin” and “integrin receptor” are used interchangeably. “Integrin” or “integrin receptor” refers to any of the many cell surface receptor proteins, also referred to as adhesion receptors which bind to extracellular matrix ligands or other cell adhesion protein ligands thereby mediating cell-cell and cell-matrix adhesion processes. The integrins are encoded by genes belonging to a gene superfamily and are typically composed of heterodimeric transmembrane glycoproteins containing α- and β-subunits. Integrin subfamilies contain a β-subunit combined with different α-subunits to form adhesion protein receptors with different specificities. The integrins are grouped into two classes, those containing the αA domain and those that do not contain the αA domain. Both classes have a βA domain. “αVβ3” and “αVβ3 integrin” are also used interchangeably, and refer to integrins comprising the αV and β3 subunits.

“Compounds” refer to a chemical entity that can comprise a peptide or polypeptide, including antibodies, phage display antibodies, and their biologically active fragments, a small molecules, (e.g., chemically synthesized or of natural origin), or synthetic peptides or polypeptides (e.g., non-naturally occurring polypeptides, e.g., peptoids or peptidomimetics). The compound has the ability to bind the integrin at an extracellular ligand binding site domain. As such, “ligand” refers to the naturally occurring ligand that binds the integrin so that it can perform its physiological function or functions. This site is distinguishable from the ligand binding site. Compounds can include synthetic and naturally occurring mimetics of the CD loop or fragments of the CD loop of the β tail domain (βTD) that contacts the strand-F/α7 loop in the βA domain of an unliganded integrin, the α1/strand-A loop or fragments of that loop that contact the hybrid domain of an unliganded integrin, and the ADMIDAS coordination site in the βA domain of an unliganded integrin. A “mimetic” has structural similarity or has similar binding properties as the entity it is mimicking. Compounds can comprise or consist of the mimetic. According to the invention, “compounds” generally refers to chemical entities as described above, selected from the group consisting of
a) naturally occurring or synthetic peptides;
b) naturally occurring or synthetic polypeptides;
c) small molecules, typically small molecules as defined below;
d) antibodies, typically antibodies selected from the group consisting of monoclonal antibodies, polyclonal antibodies, chimeric antibodies, antibody fusions, and the like;
e) antibody fragments, generally antibody fragments of antibodies as given under d); and
f) non-peptidic organic molecules, typically having a formula weight above 150 g/mol and generally less than 1500 g/mol, more typically above 250 g/mol and preferably less than 800 g/mol.

“Modulation” refers to regulating or changing the activatability or ligand binding of an integrin. For example, a modulator can inhibit or promote the activation of the integrin or it can prevent or promote ligand binding to the integrin.

A “peptidomimetic” refers to a chemical variant of a polypeptide or a peptide in which the side chains of the polypeptide or peptide are substantially maintained in the variant, yet the chemical backbone of the peptidomimetic is altered relative to the polypeptide or peptide in at least one peptide bond.

A “peptoid” is an oligomer of N-substituted glycines. A peptoid can be synthesized from a variety of different N-alkylglycines that have side chains similar to amino acid side chains, (e.g., as described in Simon et al., (1992) PNAS 89:9367-9371). It can serve as a motif for the generation of chemically diverse libraries of novel molecules. As an alternative to natural polymers, it is a modular system that allows one to synthesize monomers in large amounts. The monomers have a wide variety of functional groups presented as side chains off of an oligomeric backbone, the linking chemistry is high yielding and amenable to automation. The linkage in a peptoid is resistant to hydrolytic enzymes such as proteases. Another advantage is that the monomers are achiral.

A “small molecule” is a molecule of less than 32 kDa, e.g., 0.5 kDa, 1 kDa, 5 kDa, 10, kDa, 15 kDa, 20 kDa, 25 kDa, 30 kDa, or 32 kDa.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

### 2DESCRIPTION OF DRAWINGS

FIG. 1A is a depiction of the structure of αVβ3-Mn complexed with cyclo(RGDf-N-Me-V). This stereoview of a simulated-annealing omit map (cyan) of the peptide-integrin complex. Cutoff is 5.0 σ for Mn²⁺ and 1.0 σ for ligand residues. Densities (magenta) of the adjacent metal ions at ADMIDAS, MIDAS and LIMBS (shown here and in subsequent figures as violet, cyan and gray respectively) are from the same map.

FIG. 1B is a depiction of a ribbon drawing (M. Carson, J. Mol. Graph. 5, 103-106. (1987))of the αVβ3-RGD-Mn structure. In this and subsequent figures, αV and β3 are shown in blue and red, respectively. The peptide is bound at the propeller/βA domain interface with the ADMIDAS, MIDAS and LIMBS metal ions shown. The remaining five Mn²⁺ ions of the integrin (four in β-hairpin loops of blades 4-7 of the propeller and one at the αV genu) are shown in orange. The carbon, nitrogen and oxygen atoms of cyclo(RGDf-N-Me-V) are shown in yellow, blue and red respectively. (inset) Surface representation (A. Nicholls, K. A. Sharp, B. Honig, Proteins 11, 281-96 (1991)) of the integrin head, showing the location of the peptide binding site. The peptide is shown as a ball-and-stick model.

FIGS. 2A and 2B are depictions of the ligand-integrin binding site. FIG. 2A depicts a surface representation of the ligand binding site, with the ligand peptide shown as ball-and stick model. Color code for the ligand and the two visible Mn2+ ions (MIDAS and ADMIDAS) is as in FIGS. 1A and 1B. FIG. 2B depicts interactions between ligand and integrin. The peptide (yellow) and residues interacting with the ligand or with Mn²⁺ ions are shown in ball-and-stick representation. αV and β3 residues are labeled blue and red, respectively. Oxygen and nitrogen atoms are in red and blue, respectively. The three Mn²⁺ ions in β3 at MIDAS, ADMIDAS and LIMBS are also shown. Hydrogen bonds and salt bridges (distance cutoff 3.5 Å) are represented with dotted lines.

FIGS. 3A and 3B are depictions of the MIDAS motif in βA and FIGS. 3C and 3D are depictions of the αA from CD11b. FIGS. 3A and 3B depict MIDAS residues (single letter) in unliganded and liganded βA, respectively. Coordinating side-chains are shown as ball-and-stick with oxygen atoms in red, carbon in green. The ligand aspartate is in gold. In addition to the ligand aspartate, the Mn²⁺ (cyan) in the βA MIDAS is coordinated directly with the hydroxyl oxygens of Ser121 and Ser123 and with one carboxylate oxygen from Glu220. The carboxyl oxygens of Asp119 and Asp251 of βA lie within 6 Å of the metal ion and likely mediate additional contacts through water molecules similar to the liganded forms of αA (FIG. 3D). The Mn²⁺ ion at ADMIDAS (magenta) is present in (A) and (B). The Mn²⁺ ions at MIDAS and at LIMBS (cyan and gray respectively) are only present in (B). FIGS. 3C and 3D depict MIDAS residues in unliganded and liganded αA from CD11b, respectively. The metal ion (cyan) is present in both. Water molecules are labeled “ω”; the pseudoligand glutamate is in gold. Hydrogen bonds and metal ion coordination are represented with dotted yellow lines.

FIGS. 4A, 4B, and 4C are depictions of the ligand-induced structural changes in βA in comparison with those of αA (from CD11b). FIG. 4A depicts a superposition, in stereo, of the αVβ3-Mn (gray) and αVβ3-RGD-Mn (red) structures. The superposition is based on the Cα atoms of the central β3-sheet (43 atoms per structure, rmsd =0.42 Å). Residues of αVβ3-RGD-Mn with a distance of more than 1.5 Å to corresponding residues of αVβ3-Mn are shown with thicker red lines. The major structural changes in βA involve helices α1, α1′, α2, the Fα-7 loop and the ligand-specificity region. FIG. 4B depicts a magnified view of the rearrangements at the ligand binding site in βA. Superposition of the propeller and βA domains of αVβ3-Mn (gray) and αVβ3-RGD-Mn (αV, blue; β3, red) is based on the Cα atoms of the αV propeller domain. The directions of protein movements (including the 4Å displacement of Mn²⁺at ADMIDAS) are indicated by red arrows. This view differs from (A) by a rotation of 180° around a vertical axis. FIG. 4C depicts a superposition, in stereo, of the “liganded” (red) and “unliganded” forms of αA from the CD11b integrin. The metal ion sphere at MIDAS is in cyan. The superposition is based on the Cα atoms of the central β-sheet (43 atoms, rmsd 0.43 Å). Residues of liganded αA with a distance of more than 1.5 Å to corresponding residues of unliganded αA are shown with thicker red lines. The major structural changes in αA involve helices α1, α7, the F-α7 and E-α6 loops. Arrows (red) indicate the direction of the major protein movements in each case.

FIGS. 5A and 5B are-schematic depictions of a model for the role of βA in ligand recognition by all integrins. FIG. 5A is a cartoon representation of the propeller (blue) and β3A (pink) domains in liganded αVβ3, with RGD (yellow) contacting both subunits. The ligand D contacts the metal ion in MIDAS directly. FIG. 5B is a hypothetical model of the propeller βA domains in an αA-containing integrin. αA (light blue) projects from a loop in the propeller. We envision that an alpha-subunit derived invariant Glu at the base of the α7 helix of αA coordinates the βA MIDAS, acting as an endogenous ligand. This may occur when the α7 helix down-shifts by 10 Å, perhaps in response to inside-out signals, thus favoring binding of αA to ligand (E, dotted box). This model also allows for outside-in signaling by a liganded αA. The MIDAS metal ion is in cyan.

FIG. 5C depicts the conservation of the putative Glu in the a subunits of αA-integrins. Alignment of the primary sequence of all nine αA-integrin a subunits was carried out with CLUSTALW 1.8(F. Jeanmougin, J. D. Thompson, M. Gouy, D. G. Higgins, T. J. Gibson, Trends Biochem Sci 23, 403-5. (1998)). Only the sequence surrounding the putative endogenous Glu ligand (red) is shown. The αA c-terminal helix residues are underlined (based on structures of CD11b, CD11a, α1 and α2) (Lee et al., supra; A. Qu, D. J. Leahy, Proc. Natl. Acad. Sci. (USA) 92, 10277-10281 (1995); M. Nolte et al., FEBS Lett 452, 379-85 (1999); J. Emsley, S. L. King, J. M. Bergelson, R. C. Liddington, J Biol Chem 272, 28512-7 (1997)). Secondary structure predictions of the cup tetrapeptide and the A4 strands of the alpha subunit (J. P. Xiong et al., Science 294, 339-45. (2001)) are underlined. In the figure, amino acids are represented in single letters.

### DETAILED DESCRIPTION

Described below is structure of a αVβ3-Mn complex and a αVβ3-RGD-Mn complex. The structure was solved by x-ray crystallography. The coordinates of the atoms in the αVβ3-Mn complex are presented in Table 1. The coordinates of the αVβ3-RGD-Mn complex are presented in Table 2. Data collection and refinement statistics are in Table 3.

Expression, purification and crystallization of extracellular αVβ3 were carried out as described(Xiong et al., supra). The integrin-ligand complex (αVβ3-RGD-Mn) was generated by soaking αVβ3-Ca crystals for three days at 4° C. in 100 mM MES pH 6.0, 100 mM NaCl, 5 mM MnCl₂ and 2.4 mM cyclo(RGDf-N-Me-V). Cyclo(RGDf-N-Me-V) competes with binding of physiologic ligands to native or extracellular αVβ3 (IC⁵⁰ 0.5-3 nM)(R. J. Mehta et al., Biochem J 330, 861-9. (1998); M. A. Dechantsreiter et al., J Med Chem 42, 3033-40. (1999)), and is in clinical trials as an anti-angiogenic therapeutic. Binding of vitronectin, fibronectin and fibrinogen to extracellular αVβ3 was unaffected by the crystallization buffer used here (data not shown). Crystals of αVβ3-Mn were grown by the hanging drop method as described (Xiong et al., supra), with 5 mM MnCl₂ replacing CaCl₂ in the crystallization buffer (Table 3). All protein crystals were cryoprotected in 24% glycerol, and data were collected at 100 K at the APS beamline ID-19. Crystals of all three structures are isomorphous (Table 3). Diffraction data were sharpened with a B-factor of −40.0 Å². The αVβ3-Mn and αVβ3-RGD-Mn structures were solved by molecular replacement at 3.3 Å and 3.2 Å resolution respectively, using the previously reported αVβ3-Ca structure as the initial model. For the αVβ3-Mn structure, the original coordinates were modified by removing all six calcium ions. Coordinates were then subjected to rigid body minimization. A Fo-Fc difference map showed positive density in all six previously determined calcium-binding sites. The eight metal ion densities in the structure were all assigned as manganese because crystals were soaked with buffer containing 5 mM MnCl₂. The positions of manganese ions were confirmed from the anomalous difference Fourier maps using data collected at the wavelength 1.2398 Å, where Mn²⁺ has reasonable anomalous contribution (f′=1.96 electrons). For the αVβ3-RGD-Mn structure, a similar Fo-Fc difference density map showed clear density for all five amino acids of the cyclic peptide ligand and for eight Mn2+ ions: six at the original sites and two in the vicinity of the ligand. Each model was then modified according to the difference density features and refined using bulk solvent correction and several rounds of simulated annealing protocols in XPLOR (A. T. Brünger et al., Acta Crystallogr D Biol Crystallogr 54, 905-21. (1998)). About 5% of reflections were used to calculate the free R-factor in each case; the reflections included in the two “free sets” were the same as those used for the αVβ3-Ca structure determination.

TABLE 3

| | αVβ3-Mn | αVβ3-RGD-Mn |
|---|---|---|
| Data collection statistics* | | |
| Space group | P3₂21 | P3₂21 |
| Unit cell dimensions (Å) | a = b = 130.43, | a = b = 129.79, c = 308.78 |
| | c = 310.32 | |
| Resolution (Å) | 50.0-3.3 | 50.0-3.2 |
| Completeness | 94.4 (86.1) | 99.9 (99.4) |
| Unique reflections | 44739 (4011) | 48911 (4853) |
| Redundancy | 4.8 | 6.7 |
| Rsym (%)‡ | 9.5 (43.9) | 16.4 (40.0) |
| I/σ | 16.1 (2.5) | 14.0 (3.7) |
| Refinement statistics | | |
| Resolution (Å) | 20.0-3.3 | 20.0-3.2 |
| R_{factor}¶ (%) (work set) | 24.2 | 24.9 |
| R_{factor} (%) (free set) | 32.3 | 33.0 |
| Average B factor (Å²) | 44.8 | 36.0 |
| Protein atoms in the model | 11651 | 11692 (including peptide) |
| Number of Glc-NAc | 11 | 11 |
| Number of Mn²⁺ | 6 | 8 |
| Model statistics | | |
| Rmsd# from ideality | | |
| Bond lengths (Å) | 0.01 | 0.009 |
| Bond angles (°) | 1.7 | 1.7 |
| Dihedral angles (°) | 26.4 | 26.7 |

*Values in parentheses are for the highest resolution shell.
‡R_{sym} = Σ|I − <I>|/Σ I, where I is the observed intensity and <I> is the average intensity from multiple observations of symmetry-related reflections.
¶R_{factor} = Σₕₖₗ |F_{obs}(hkl) − F_{calc}(hkl)|/Σₕₖₗ F_{obs}(hkl).
#root mean square deviation

The crystal structure of the extracellular segment of the αA-lacking integrin αVβ3 was recently determined in the presence of Ca²⁺ (αVβ3-Ca) (Xiong et al., supra). The αVβ3-Ca structure has twelve domains assembled into an ovoid head and two “legs.” The head is primarily formed of a seven-bladed β-propeller domain from the αV subunit [SEQ ID NO:2] and a βA A-type domain from the β3 subunit [SEQ ID NO:3]. In solution, the crystallized αVβ3 segment binds its cognate ligands in a manner indistinguishable from that of the native high-affinity receptor (R. J. Mehta et al., supra), suggesting that it is ligand-competent.

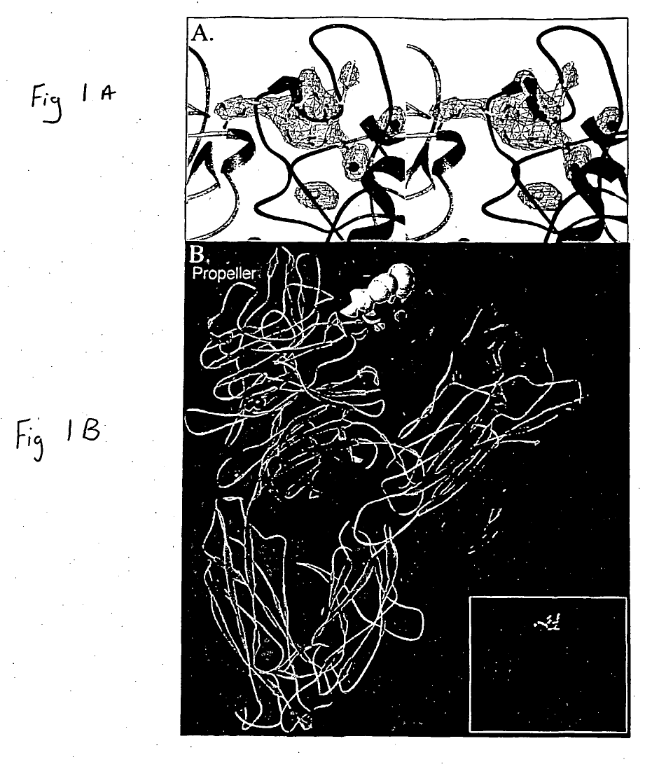

Described herein is the structure of the extracellular segment of integrin αVβ3 in complex with the cyclic pentapeptide ligand Arg-Gly-Asp-(D-Phe)-(N-methyl-Val) “cyclo(RGDf-N-Me-V)” [SEQ ID NO: 1] or “RGD peptide” (M. A. Dechantsreiter et al., supra) in the presence of Mn²⁺ (αVβ3-RGD-Mn) is described herein (Table 2). The structure of the unliganded αVβ3 protein in the presence of Mn²⁺ (αVβ3-Mn) has also been determined for comparison and is described herein (Table 1). The two structures contain the previously reported extracellular residues of the integrin (Xiong et al., supra). In addition, αVβ3-Mn contains six Mn²⁺ ions (replacing each Ca²⁺ ion in αVβ3-Ca), and αVβ3-RGD-Mn contains the cyclic pentapeptide plus eight Mn2+ ions. Replacement of Ca²⁺ with Mn²⁺ at all six sites in the αVβ3-Mn structure did not result in significant structural rearrangements in the integrin. As with αVβ3-Ca (Xiong et al., supra), no metal ion is visible at MIDAS in αVβ3-Mn, although the millimolar concentration of Mn²⁺ used far exceeds those needed for maximal ligand binding (R. J. Mehta et al., supra). FIGS. 1A and 1B show respectively a representative electron density omit map and a ribbon diagram of the integrin-pentapeptide complex.

The αVβ3-RGD-Mn structure reveals that the pentapeptide inserts into a crevice between the propeller and βA domains, on the integrin head (FIG. 1B, and inset). As the protein in the crystal binds ligand, this confirms that αVβ3-Mn is in a “ligand-competent” state. The bound peptide is pentagonal as expected; its side chains radiate outwards. The RGD peptide sequence makes the main contact area with the integrin, and each residue participates extensively in the interaction, which buries 355 Å² or 45% of the total surface area of the peptide. Arg and Asp side chains point in opposite directions, exclusively contacting the propeller and βA domains, respectively. Thus the peptide clamps the subunits together at the head. The five Cα-atoms of the cyclic peptide form a slightly distorted pentagon, with the Cα atoms of Arg and Asp farther apart from each other (distance=6.4 Å) than the Cα atoms of Gly and D-Phe (distance 5.4 Å). The NMR structure of this peptide in solution (M. A. Dechantsreiter et al., supra) suggested a more regular pentagonal conformation. Molecular dynamics simulations of the peptide in the absence of the integrin, performed using the same geometric parameters used for the crystallographic refinement, also result in a more regular pentagonal shape with roughly equal inter-Cα-atom distances (data not shown). Thus; distortion of the peptide ring apparently develops following contact with αVβ3-Mn. The main chain conformation of the RGD motif in the pentapeptide is almost identical to that of the RGD tripeptide in the natural ligand Echistatin (R. A. Atkinson, V. Saudek, J. T. Pelton, Int J Pept Protein Res 43, 563-72. (1994)), suggesting that the structure presented here can serve as a basis for understanding the interaction of integrins with other RGD-containing ligands.

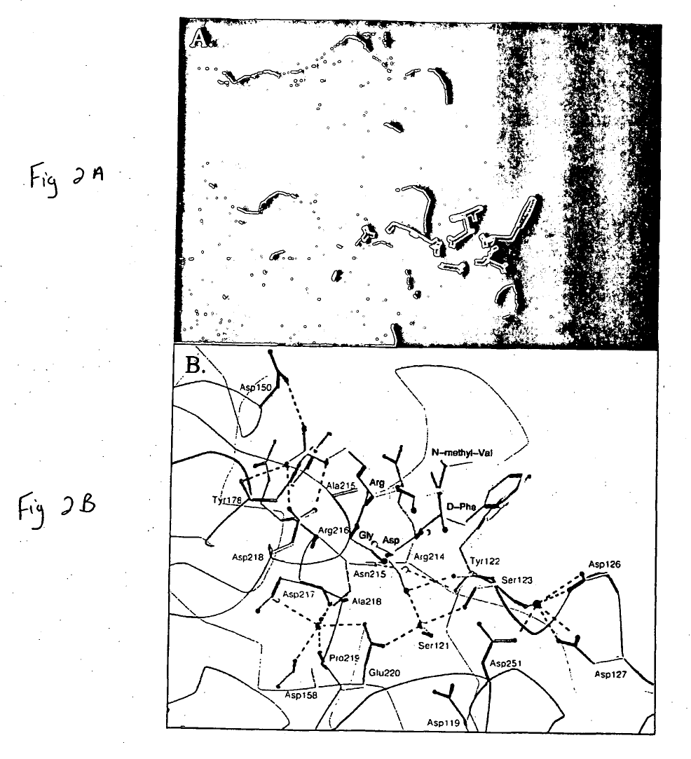

The Arg side-chain inserts into a narrow groove at the top of the propeller domain, formed by the D3-A3, A3-B3 and D4-A4 loops (FIG. 2A). The arginine guanidinium group is held in place by a bidentate salt bridge to αV:Asp218 at the bottom of the groove, and by an additional salt bridge to αV:Asp150 at the rear. The hydrophobic portion of the. Arg side-chain is sandwiched between the side-chains of αV residues Tyr178 and Ala215, which form the walls of the groove (FIG. 2B). The contacts leave most of the upper portion of the Arg side-chain exposed to solvent, while the spacious rear of the groove probably contains water molecules that may provide additional contacts to the Arg guanidinium group.

Contacts between the ligand Asp and βA primarily involve the Asp carboxylate group, which protrudes into a cleft between the βA loops A′-α1 and C′-α3 and forms the center of an extensive network of polar interactions (FIGS. 2A, 2B). One of the Asp carboxylate oxygens contacts a Mn²⁺ ion at MIDAS in βA (FIG. 2B); it also hydrogen bonds to the carbonyl oxygen of β3:Tyr122. The second Asp carboxyl oxygen forms hydrogen bonds with the backbone amides of β3:Tyr122 and β3:Asn215 (FIG. 2B) and also contacts the hydrophobic portion of the β3:Arg214 side-chain. Additional contacts involve the hydrophobic portion of the Asp side-chain and the CB atom of β3 :Asn215. Unlike the ligand Arg, the ligand Asp side-chain is completely buried in the complex.

The glycine residue, which completes the prototype RGD ligand sequence, lies at the interface between the α and β subunits. It makes hydrophobic interactions with Arg216, Asp217 and Ala218 of βA and with Tyr178 of αV (FIG. 2B). The most critical of these interactions appears to be the contact with the carbonyl oxygen of β3:Arg216, which closely approaches the CA atom of the glycine. The remaining two residues of the pentapeptide face away from the αβ interface and are not in the consensus ligand sequence. The D-Phe side-chain packs against βA residues Tyr122 and Ser123; the N-methyl valine does not contact the integrin.

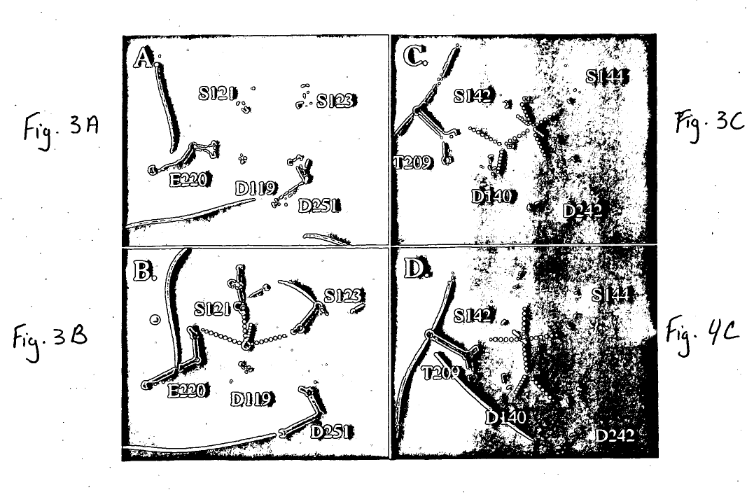

It is striking that the peptidal aspartate contacts βA in a manner that closely resembles the interaction of αA with its ligands (Lee et al., supra; Emsley et al., supra) (FIG. 3): in both cases, an acidic ligand residue coordinates the receptor via a metal ion in MIDAS. Since MIDAS in the unliganded αVβ3-Ca or αVβ3-Mn structures does not contain a metal ion, it appears that completion of the coordination by the ligand carboxylate is required for high-affinity metal binding here. This differs from αA, which can bind a metal ion in MIDAS without a ligand (Qu et al., supra; Lee et al., supra). Thus the MIDAS site of βA has a lower affinity for cations than the very similar site in αA. The one difference between the two sites is the replacement of a Thr, which contacts the cation in liganded αA, with Glu220 in βA. In the unliganded αVβ3-Mn structure, the Glu220 side-chain intrudes into the MIDAS site, approaching the space where a cation would bind: it thus appears to reduce the affinity for cations at MIDAS through steric hindrance. In the liganded αVβ3-RGD-Mn structure, the β3:Glu220 side-chain occupies a different position, allowing accommodation of a cation at MIDAS.

In addition to incorporating Mn²⁺ at MIDAS upon ligand binding, β3A also unexpectedly incorporates a second Mn²⁺ ion. Only 6 Å from MIDAS, this ion defines a ligand-induced metal-binding-site.(LIMBS) formed by the other carboxylate oxygen of β3:Glu220, the side chains of β3:Asp 158, β3:Asn215 and β3:Asp217 and the carbonyl oxygens of β3:Asp217 and β3:Pro219 (FIG. 2B). Although the LIMBS Mn²⁺ ion does not contact the ligand, coordination of Mn²⁺ nevertheless depends on it. β3:Asp158 and β3:Glu220 occupy different positions in the unliganded structure, and the coordination sphere for LIMBS does not exist without the ligand. The incoming ligand Asp displaces β3:Asn215 and also shifts the β3:Glu220 side-chain, thus inducing this metal binding site. The most likely role of LIMBS is to stabilize the reoriented β3:Glu220 and to add conformational stability and structural rigidity to the ligand binding surface.

The present data provide the structural basis for the RGD consensus in αVβ3 ligands, where even conserved substitutions such as Arg to Lys, Gly to Ala or Asp to Glu are not tolerated (R. J. Mehta et al., supra; M. A. Dechantsreiter et al., supra): the shorter side chain of Lys (vs. Arg) cannot make a bidentate salt bridge to β3 :Asp218 in αVβ3; interestingly, an Arg to Lys substitution is accommodated in the αIIβ3 integrin (R. M. Scarborough et al., J Biol Chem 268, 1066-73. (1993)), which lacks an αV:Asp218-corresponding residue and likely contacts the Arg side-chain in a different manner. Substitution of Gly with any other amino acid would introduce a severe clash between that residue's side-chain and the carbonyl oxygen of β3:Arg216; the longer side-chain of Glu (vs. Asp).in the context of RGD, would result in steric clashes with residues on the ligand binding interface of αVβ3. The structure of the complex also explains the loss of ligand binding observed in natural or experimental mutations in β3 integrins. β3:Asp119 to Tyr (J. C. Loftus et al., Science 249, 915-8. (1990)) and β3:Arg214 to Trp or Gln (M. L. Bajt, M. H. Ginsberg, A. L. Frelinger, M. C. Bemdt, J. C. Loftus, J. Biol. Chem. 267, 3789-3794 (1992)) are naturally-occurring loss of function mutations of β3 seen in patients with the bleeding disorder thrombasthenia: β3:Asp119 is a MIDAS residue likely involved in indirect metal ion coordination. The β3:Arg214 side chain lies within 5 Å from the ligand Asp, and thus a substitution with Trp or Gln will likely change the ligand binding surface. Alanine substitutions of β3:Glu220 or Asp217 (or their equivalents in β1 and the αA-containing β2 integrins) also abolish ligand binding (W. Puzon-McLaughlin, Y. Takada, J. Biol. Chem. 271, 20438-20443 (1996); E. C. Tozer, R. C. Liddington, M. J. Sutcliffe, A. H. Smeeton, J. C. Loftus, J Biol Chem 271, 21978-84. (1996); T. G. Goodman, M. L. Bajt, J Biol Chem 271, 23729-36. (1996)): β3:Glu220 directly coordinates the metal ion at MIDAS; Asp217 is part of LIMBS, which helps position β3:Glu220 for optimal metal ion accommodation in MIDAS.

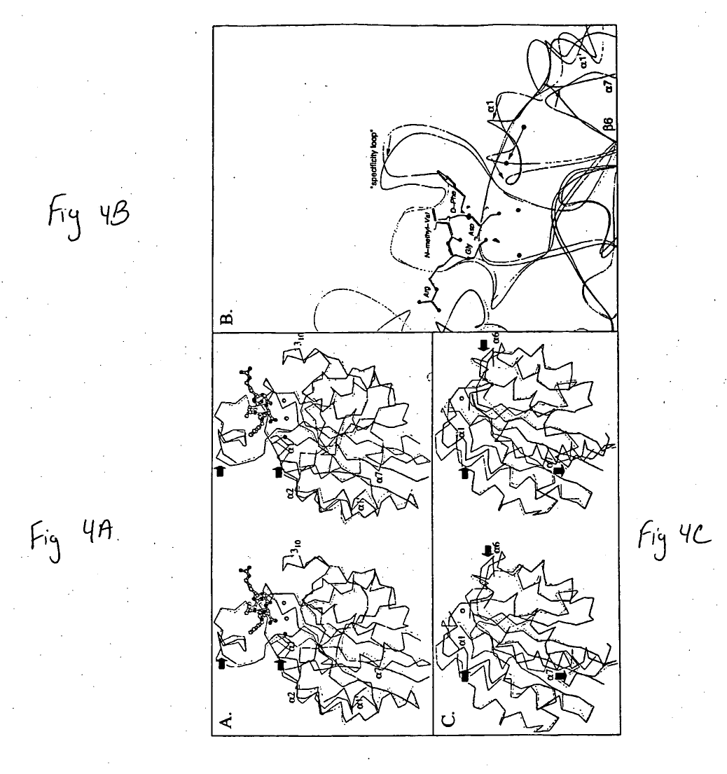

Binding of the pentapeptide ligand induces tertiary and quaternary changes in αVβ3-Mn. Changes in tertiary structure involve βA, affecting primarily its α1-α2 loops/helices, α2-C′, Fα7 and B-C (“ligand specificity”) loops (FIGS. 4A, 4B). The observed movements appear to be causally linked to the top of helix at which approaches MIDAS, permitting contacts with both MIDAS cation and ligand through β3:Ser121, β3:Tyr122 and β3:Ser123. In the complex, the backbone amide and carbonyl oxygens of β3:Tyr122 directly contact the ligand Asp, and both serine side chains coordinate the MIDAS cation. Thus α1 is fastened to the ligand/MIDAS assembly within the complex. The ADMIDAS cation moves in concert with α1 since it is primarily coordinated by α1 residues β3:Asp126 and β3:Asp127. Most of the remaining ligand-induced structural changes can be viewed as indirectly caused by the shift of α1:α1′ directly follows al in sequence, and α2 and the top of α7 flank α1′. The ligand-specificity region also approaches the ligand. This movement may be related to a salt bridge in this region between β3:Asp179 and β3:Arg214. β3:Arg214 is near the ligand Asp, and it does not form a salt bridge to β3:Asp179 in the unliganded structure. The functional implications of these changes are indicated by the location in the α1-α2 segment of βA of epitopes both for activation and inhibitory monoclonal antibodies (Y. Takada, W. Puzon, J. Biol. Chem. 268, 17597-17601 (1993); A. Mould, A. Garratt, J. Askari, S. Akiyama, M. Humphries, FEBS Lett. 363, 118-22 (1995); A. Andrieux, M. J. Rabiet, A. Chapel, E. Concord, G. Marguerie, J Biol Chem 266, 14202-7. (1991); C. Lu, M. Shimaoka, Q. Zang, J. Takagi, T. A. Springer, Proc Natl Acad Sci U S A 98, 2393-8. (2001)).

Interestingly, the above ligand-induced movements in βA resemble the rearrangements in the α1 helix and the F-α7 loop in αA that accompany its transition from the “unliganded” low-affinity to the “liganded’ high-affinity form (Emsley et al., supra; Xiong et al., supra; Lee et al., supra) (FIG. 4). In αA, a major distinguishing feature of this transition is a 10 Å downward shift of the c-terminal α7 helix with realignment of its hydrophobic contacts (Xiong et al., supra) (FIG. 4C). However, the position of the α7 helix in liganded βA does not change (it already occupies an equivalent position to liganded αA when ligand is absent). One interpretation of these data is that the conformation of βA in the unliganded αVβ3-Mn and αVβ3-Ca structures is a ligand-competent (high-affinity) conformation of the A-type domain when activated in the context of an integrin heterodimer. An alternative interpretation is that this ligand-competent conformation is unique to βA, and that Glu220 (which is conserved in βA but not αA domains) ensures a low affinity state of βA until ligand becomes available.

Quaternary rearrangements in the integrin head region are also observed in the complex. The interface between βA and the αV propeller undergoes a small change, with the two domains moving slightly closer together at the peptide binding site. The net effect of peptide binding is to “close up” the binding site. In addition, the propeller undergoes a small rotation at the propeller/thigh interface, with βA moving in concert.

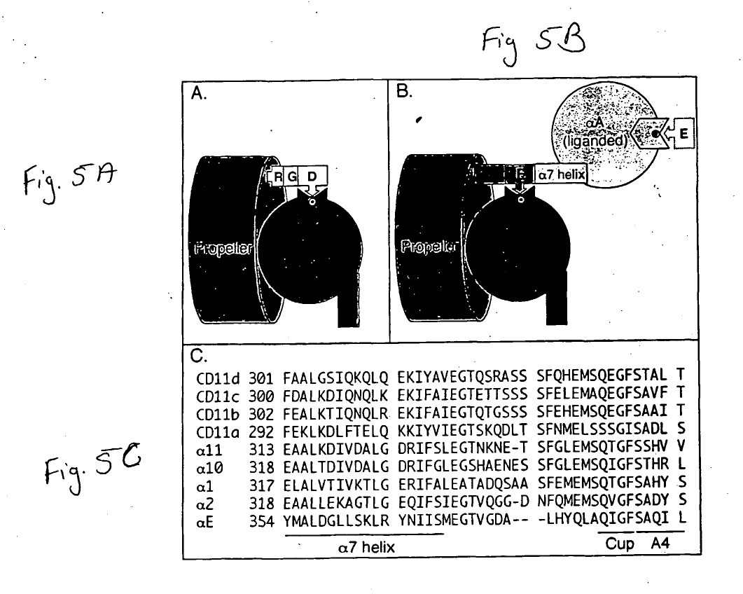

It is remarkable that the smallest tripeptide recognition motif in an integrin ligand produces detectable changes both quaternary and tertiary structure (noted above), even within the constrained crystal lattice of the heterodimeric receptor. Natural integrin ligands are significantly larger, structurally diverse and often multivalent, and are therefore expected to induce conformational changes in addition to those produced here by the pentapeptide ligand. We expect that the diversity of the cellular responses will reflect the spectrum of such tertiary and quaternary changes in the integrins. These rearrangements are not restricted to αA-lacking integrins but are a general feature of all integrins. Although the isolated αA binds ligand when activated, an intact βA is also needed for ligand binding in the αA containing integrin heterodimer, albeit indirectly (W. Puzon-McLaughlin et al., supra; C. Lu, M. Shimaoka, supra). Therefore interactions between αA and βA may regulate ligand binding in αA-containing integrins. The location of the RGD-binding site in αVβ3 suggests a tantalizing hypothesis for how such regulation might occur: in αA-integrins, αA emanates from the propeller's D3-A3 loop, which forms part of the ligand Arg binding pocket in αA-lacking integrins such as αVβ3 (FIG. 2B). The termini of αA, and perhaps part of the domain itself, are expected to lie above the MIDAS motif of βA, and a potential interaction between the two domains might involve residues in the vicinity of the βA MIDAS motif. We note that immediately c-terminal to the α7 helix of αA, there is an invariant Glu existing in a different Ile-Glu-Gly-Thr consensus (FIG. 5). This Glu could act as an endogenous ligand for the βA MIDAS when αA is activated, enabling it to stably bind exogenous ligand. Liganded αA could also use the Glu “hook” to transmit outside-in signals. The basic tertiary and quaternary changes observed in the present structure may thus be applicable to all integrins.

Computer Modeling

The methods of the invention employ computer-based methods for identifying compounds having a desired structure. These computer-based methods fall into two broad classes: database methods and de novo design methods. Database methods fall in two main classes, those based on a compound (i.e., a ligand of a binding site alone) or those based on the three dimensional structure of the binding site. In the former approach, the compound of interest is compared to all compounds present in a database of chemical structures and compounds whose structure is in some way, similar to the compound of interest are identified. In the latter approach, all compounds in a database are docked by appropriate computer software into the binding site, and their degree of fit is evaluated and ranked. The structures in the database are based on either experimental data, generated by NMR or x-ray crystallography, or modeled three-dimensional structures based on two-dimensional protein or DNA sequence data.

In de novo design methods, models of compounds whose structure is in some way similar to the compound of interest are generated by a computer program using information derived from known structures (e.g., data generated by x-ray crystallography and/or theoretical rules). Such design methods can build a compound having a desired structure in either an atom-by-atom manner or by assembling stored small molecular fragments.

The success of both database and de novo methods in identifying compounds with activities similar to the compound of interest depends on the identification of the functionally relevant portion of the compound of interest. For drugs, the functionally relevant portion is referred to as a pharmacophore. A pharmacophore, then, is an arrangement of structural features and functional groups important for biological activity.

Not all identified compounds having the desired pharmacophore will act as an integrin modulator. The actual activity can be finally determined only by measuring the activity of the compound in relevant biological assays. However, the methods of the invention are extremely valuable because they can be used to greatly reduce the number of compounds which must be tested to identify an actual mimetic.

Programs suitable for generating predicted three-dimensional structures from two-dimensional data include: Concord (Tripos Associated, St. Louis, Mo.), 3-D Builder (Chemical Design Ltd., Oxford, U.K.), Catalyst (Bio-CAD Corp., Mountain View, Calif.), Daylight (Abbott Laboratories, Abbott Park, Ill.).

Programs suitable for searching three-dimensional databases to identify molecules bearing a desired pharmacophore include: MACCS-3D and ISIS/3D (Molecular Design Ltd., San Leandro, Calif.), ChemDBS-3D (Chemical Design Ltd., Oxford, U.K.), Sybyl/3DB Unity (Tripos Associates, St. Louis, Mo.). Programs suitable for pharmacophore selection and design include: DISCO (Abbott Laboratories, Abbott Park, Ill.), Catalyst (Bio-CAD Corp., Mountain View, Calif.), and ChemDBS-3D (Chemical Design Ltd., Oxford, U.K.).

Databases of chemical structures are available from Cambridge Crystallographic Data Centre (Cambridge, U.K.) and Chemical Abstracts Service (Columbus, Ohio).

De novo design programs include Ludi (Biosyr Technologies Inc., San Diego, Calif.) and Aladdin (Daylight Chemical Information Systems, Irvine Calif.), LEGEND (Nishibata, Y., Itai, A., Tetrahedron, 47, 8985 (1991))(Molecular Simultations, Burlington, Mass.), and LeapFrog (available from Tripos associates, St. Louis, Mo.).

Upon determination of the three-dimensional structure of an integrin, a potential modulator can be evaluated by any of several methods, alone or in combination. Such evaluation can utilize visual inspection of a three-dimensional representation of the binding site on the integrin, based on the x-ray coordinates of a crystal described herein, on a computer screen. Evaluation, or modeling, can be accomplished through the use of computer modeling techniques, hardware, and software known in the art. This can additionally involve model building, model docking, or other analysis of protein-ligand interactions using software including, for example, QSC, GOLD (Jones et al., J. Mol. Biol., 245, 43-53, 1995), FlexX (Lengauer, Rarey, 1996), Autodock (Morris et.al., 1998), GLIDE, Modeler, or Sybyl, followed by energy minimization and molecular dynamics with standard molecular mechanics forcefields including, for example, CHARMM and AMBER. The three-dimensional structural information of an unliganded integrin, (e.g., the CD loop of the βTD contacting the strand-F/α7 loop of the βA domain in an unliganded integrin) can also be utilized in conjunction with computer modeling to generate computer models of other unliganded integrins. Computer models of unliganded integrin structures can be created using standard methods and techniques known to those of ordinary skill in the art, including software packages described herein.

Once the three-dimensional structure of a crystal, or solution structure via NMR, comprising an unliganded integrins determined, a potential non-ligand site binder (e.g., a binder that mimics the βTD binding of the strand-F/α7 loop of the βA domain) is examined through the use of computer modeling using a docking program such as QSC, GOLD, FlexX, or Autodock to identify potential non-ligand binding site binders to ascertain how well the shape and the chemical structure of the potential ligand will interact with the binding site. Computer programs can also be employed to estimate the attraction, repulsion, and steric hindrance of the two binding partners (i.e., the non-ligand binding site and the modulating binder). Generally tighter fit, lower steric hindrances, and greater attractive force between the potential ligand and the allosteric binding site are consistent with a tighter binding constant between the two. Furthermore, the more specificity in the design of a potential drug, the more likely that the drug will also not interact with other proteins. This will minimize potential side-effects due to unwanted interactions with other proteins.

A variety of methods are available to one skilled in the art for evaluating and virtually screening molecules or chemical fragments appropriate for associating with a protein, particularly an integrin. Such association can be in a variety of forms including, for example, steric interactions, van der Waals interactions, electrostatic interactions, solvation interactions, charge interactions, covalent bonding interactions, non-covalent bonding interactions (e.g., hydrogen-bonding interactions), entropically or enthalpically favorable interactions, and the like.

Numerous computer programs are available and suitable for rational drug design and the processes of computer modeling, model building, and computationally identifying, selecting and evaluating potential modulating compounds in the methods described herein. These include, for example, QSC (WO 01/98457), FlexX, Autodock, Glide, Accelrys' Discovery Studio, or Sybyl. Potential inhibitors can also be computationally designed “de novo” using such software packages as QSC (WO 01/98457), Accelrys' Discovery Studio, Sybyl, ISIS, CheniDraw, or Daylight. Compound deformation energy and electrostatic repulsion, can be evaluated using programs such as GAUSSIAN 92, AMBER, QUANTA/CHARMM, AND INSIGHT II/DISCOVER.

There are a number of ways to select moieties to fill individual binding pockets. These include QUANTA [Molecular Simulations, Inc., Burlington, Mass., 1992], SYBYL [Molecular Modeling Software, Tripos Associates, Inc., St. Louis, Mo., 1992], AMBER [S. J. Weiner, P. A. Kollman, D. A. Case, U.C. Singh, C. Ghio, G. Alagona, and P. Weiner, J. Am. Chem. Soc., vol. 106, pp. 765-784 (1984)], or CHARMM [B. R. Brooks, R. E. Bruccoleri, B. D. Olafson, D. J. States, S Swaminathan, and M. Karplus, J. Comp. Chem. vol. 4, pp. 187-217 (1983)]. This modeling step may be followed by energy minimization with standard molecular mechanics forcefields such as CHARMM and AMBER. In addition, there are a number of more specialized computer programs to assist in the process of selecting the binding moieties of this invention. These include:
1.) GRID (Goodford, P. J. A Computational Procedure for Determining Energetically Favorable Binding Sites on Biologically Important Macromolecules. J. Med. Chem., 28, pp. 849-857 (1985)). GRID is available from Oxford University, Oxford, UK.
2.) MCSS (Miranker, A.; Karplus, M. Functionality Maps of Binding Sites: A Multiple Copy Simultaneous Search Method. Proteins: Structure, Function and Genetics, 11, pp. 29-34 (1991)). MCSS is available from Molecular Simulations, Burlington, Mass.
3.) AUTODOCK (Goodsell, D. S.; Olsen, A. J. Automated Docking of Substrates to Proteins by Simmulated Annealing. PROTEINS: Structure, Function and Genetics, 8, pp. 195-202 (1990)). AUTODOCK is available from the Scripps Research Institute, La Jolla, Calif.
4.) DOCK (Kuntz, I. D.; Blaney, J. M.; Oatley, S. J.; Langridge, R.; Ferrin, T. E. A Geometric Approach to Macromolecule-Ligand Interactions. J. Mol. Biol., 161, pp. 269-288 (1982)). DOCK is available from the University of California, San Francisco, Calif.
5.) GOLD (Jones et al., J. Mol. Biol., 245, 43-53, 1995). GOLD is available from the Cambridge Crystallography Data Centre, Camdridge, UK.
6.) FlexX (T. Lengauer and M. Rarey, Computational Methods for Biomolecular Docking, Current Opinion in Structural Biology, Vol. 6, pp. 402-406, 1996). FlexX is available through Tripos Associated, St. Louis, Mo.
   These computer evaluation and modeling techniques can be performed on any suitable hardware including for example, workstations available from Silicon Graphics, Sun Microsystems, and the like. These techniques, methods, hardware and software packages are representative and are not intended to be comprehensive listing. Other modeling techniques known in the art can also be employed in accordance with this invention. See for example, QSC (WO 01/98457), FlexX, Autodock, Glide, Accelrys' Discovery Studio, or Sybyl and software identified at various internet sites (e.g.,
netsci.org/Resources/Software/Modeling/CADD/
ch.cam.ac.uk/SGTL/software.html
cmm.info.nih.gov/modeling/universal_software.html
dasher.wustl.edu/tinker/
zeus.polsl.gliwice.pl/nikodem//linux4chemistry.html
nyu.edu/pages/mathmol/software.html
msi.umn.edu/user_support/software/MolecularModeling.html
us.expasy.org/
sisweb.com/software/model.htm).

A potential integrin modulator can be selected by performing rational drug design with the three-dimensional structure (or structures) determined for the ligand binding site as described herein, in conjunction with or solely by computer modeling and methods described above. The potential modulator can be obtained from commercial sources or synthesized from readily available starting materials using standard synthetic techniques and methodologies known in the art. The potential inhibitor can then be assayed to determine its ability to modulate the target (e.g., integrin, e.g., αVβ3) and/or integrin pathway.

A potential modulator can also be selected by screening a library of compounds (e.g., a combinatorial library, e.g., a mass-coded combinatorial library). The library of compounds can be screened by affinity screening in which members with the greatest affinity to a particular integrin at the new non-ligand binding site can be selected.

Once suitable binding moieties have been selected, they can be assembled into a single modulating binder. This assembly may be accomplished by connecting the various moieties to a central scaffold. The assembly process can, for example, be done by visual inspection followed by manual model building, again using software such as Quanta or Sybyl. A number of other programs may also be used to help select ways to connect the various moieties. These include: CAVEAT (Bartlett, P. A.; Shea, G. T.; Telfer, S. J.; Waterman, S. CAVEAT: A Program to Facilitate the Structure-Derived Design of Biologically Active Molecules. In “Molecular Recognition in Chemical and Biological Problems,” Special Pub., Royal Chem. Soc., 78, pp. 182-196 (1989))(available from the University of California, Berkeley, Calif.); 3D Database systems such as MACCS-3D (MDL Information Systems, San Leandro, Calif. (reviewed by Martin (Martin, Y. C. 3D Database Searching in Drug Design. J. Med. Chem., 35, pp. 2145-2154 (1992))); and HOOK (available from Molecular Simulations, Burlington, Mass.).

A number of techniques commonly used for modeling drugs may be employed (for a review, see: Cohen, N. C.; Blaney, J. M.; Humblet, C.; Gund, P.; Barry, D. C., “Molecular Modeling Software and Methods for Medicinal Chemistry”, J. Med. Chem., 33, pp. 883-894 (1990)). There are likewise a number of examples in the chemical literature of techniques that can be applied to specific drug design projects (for a review, see: Navia, M. A. and Murcko, M. A., “The Use of Structural Information in Drug Design”, Current Opinions in Structural Biology, 2, pp. 202-210 (1992)). Some examples of these specific applications include: Baldwin, J. J. et al., “Thienothiopyran-2-sulfonamides: Novel Topically Active Carbonic Anhydrase Inhibitors for the Treatment of Glaucoma”, J. Med. Chem., 32, pp. 2510-2513 (1989); Appelt, K. et al., “Design of Enzyme Inhibitors Using Iterative Protein Crystallographic Analysis”, J. Med. Chem., 34, pp. 1925-1934 (1991); and Ealick, S. E. et al., “Application of Crystallographic and Modeling Methods in the Design of Purine Nucleotide Phosphorylase Inhibitors” Proc. Nat. Acad. Sci USA, 88, pp. 11540-11544 (1991).

A variety of conventional techniques can be used to carry out each of the above evaluations as well as the evaluations necessary in screening a candidate compound in modulation (e.g., inhibition) of an integrin. Generally, these techniques involve determining the location and binding proximity of a given moiety, the occupied space of a bound modulator (e.g., inhibitor), the deformation energy of binding of a given compound and electrostatic interaction energies. Examples of conventional techniques useful in the above evaluations include: quantum mechanics, molecular mechanics, molecular dynamics, Monte Carlo sampling, systematic searches and distance geometry methods (G. R. Marshall, Ann. Ref. Pharmacol. Toxicol., 27, p. 193 (1987)). Computer software has been developed for use in carrying out these methods. Examples of programs designed for such uses include: Gaussian 92, revision E.2 (M. J. Frisch, Gaussian, Inc., Pittsburgh, Pa. ©1993); AMBER, version 4.0 (P. A. Kollman, University of California at San Francisco, ©1993); QUANTA/CHARMM [Molecular Simulations, Inc., Burlington, Mass. ©1992]; and Insight II/Discover (Biosysm Technologies Inc., San Diego, Calif. (1992). These programs can be implemented, for instance, using a Silicon Graphics Indigo 2 workstation or IBM RISC/6000 workstation model 550. Other hardware systems and software packages will be known to those skilled in the art.

Conventional Screening

In addition to computer-based technologies, the invention includes the use of assays for conventional drug library screening to directly identify compounds capable of modulating the interaction between these two domains, and/or to evaluate whether a compound identified by a computer-based method modulates the activity of the integrin.

These assays can be based on binding and interaction assays, e.g., assays where one partner is marked (e.g., by biotin or fluorescent labeling) and the other partner immobilized (e.g., on 96-well ELISA plates). Compound libraries can be screened for their ability to enhance or block the interaction between the immobilized and the added biotinylated or fluorescent partner.

Binding interaction can be measured by anti-biotin antibodies, or fluorescence spectrometry, e.g., using an assay analogous to the method described herein for the αVβ3-vitronectin binding assay. Many other labeling technologies known in the art can be used in this method (e.g., radioactive marking, proximity assay).

Alternatively, the interaction between the domains can be generated in a yeast two-hybrid system, using the βA domain (or larger protein fragment containing that domain) as bait and the βTD domain (or larger protein fragment containing that domain) as prey. Compound libraries can be tested for their ability to perturb the transcription of a suitable marker gene on a Gal4 promoter.

Compound Synthesis

Synthetic chemistry transformations and protecting group methodologies (protection and deprotection) useful in synthesizing the modulating compounds described herein are known in the art and include, for example, those such as described in R. Larock, Comprehensive Organic Transformations, VCH Publishers (1989); T. W. Greene and P. G. M. Wuts, Protective Groups in Organic Synthesis, 2nd ed., John Wiley and Sons (1991); L. Fieser and M. Fieser, Fieser and Fieser's Reagents for Organic Synthesis, John Wiley and Sons (1994); and L. Paquette, ed., Encyclopedia of Reagents for Organic Synthesis, John Wiley and Sons (1995), and subsequent editions thereof.

The modulating compounds described herein can contain one or more asymmetric centers and thus occur as racemates and racemic mixtures, single enantiomers, individual diastereomers and diastereomeric mixtures. All such isomeric forms of these compounds are expressly included in the present invention. The modulating compounds described herein can also be represented in multiple tautomeric forms, all of which are included herein. The modulating compounds can also occur in cis- or trans- or E- or Z-double bond isomeric forms. All such isomeric forms of such modulating compounds are expressly included in the present invention.

Conservative Amino Acid Substitution

Peptide mimetic compounds can have a different amino acid content as the RGD peptide of SEQ ID No. 1 and serve as a useful mimetic. Substitution mutants can include amino acid residues that represent either a conservative or non-conservative change (or, where more than one residue is varied, possibly both). A “conservative” substitution is one in which one amino acid residue is replaced with another having a similar side chain. Families of amino acid residues having similar side chains have been defined in the art. These families include amino acids with basic side chains (e.g., lysine, arginine, histidine), acidic side chains (e.g., aspartic acid, glutamic acid), uncharged polar side chains (e.g., glycine, asparagine, glutamine, serine, threonine, tyrosine, cysteine), nonpolar side chains (e.g., alanine, valine, leucine, isoleucine, proline, phenylalanine, methionine, tryptophan), beta-branched side chains (e.g., threonine, valine, isoleucine) and aromatic side chains (e.g., tyrosine, phenylalanine, tryptophan, histidine). The invention includes polypeptides that include one, two, three, five, or more conservative amino acid substitutions, where the resulting mutant polypeptide binds an extracellular ligand binding site of the integrin αVβ3.

Fragments or other mutant nucleic acids can be made by mutagenesis techniques well known in the art, including those applied to polynucleotides, cells, or organisms (e.g., mutations can be introduced randomly along all or part of the nucleic acid encoding the RGD peptide of SEQ ID No. 1 by saturation mutagenesis), and the resultant proteins can be screened for ability to inhibit integrin activation as seen in one or more of the following assays.

Integrin Inhibition Assays

The integrin-modulating ability of compounds identified by the methods of the present invention can be assessed by testing in one or more of the following assays as described in detail below and further described in U.S. Pat. No. 6,489,333: Purified αVβ3 (human placenta)—Vitronectin ELISA, αVβ3—Vitronectin Binding Assay, Human Aortic Smooth Muscle Cell Migration Assay, In Vivo Angiogenesis Model, Pig Restenosis Model, Mouse Retinopathy Model. The assays are assumed to be made appropriate for the integrin of interest and the following are not limiting and merely serve as examples. A compound identified by the present invention is considered to be active if it has an IC₅₀ or Kᵢ value of less than about 10 μM for the inhibition of αVβ3-Vitronectin Binding Assay, with compounds preferably having Kᵢ values of less than about 0.1 μM. Tested compounds of the present invention are active in the αVβ3 -Vitronectin Binding Assay as well as in cell-based assays of integrin adhesion mediated by the αVβ3-receptor. Generally, the assays can be adopted to more appropriately apply to the particular integrin of interest. For example, use of the appropriate ligand (e.g., RGD-containing, e.g., fibrinogen, vitronectin, fibronectin, thrombospondin, laminin, collagen, VCAM-1, ICAM-1, ICAM-2, Factor X, osteopontin, bone sialoprotein, or vWF), use of appropriate cell types, and use of appropriate conditions which is knowledge readily available to one skilled in the art. The assays that follow are useful for detecting modulation, e.g., inhibition of αVβ3, and can also be directly applied to the testing of other integrins, or may be minimally modified for appropriate use for other integrins.

Purified αVβ3 (human placenta)—Vitronectin ELTSA

The αVβ3 receptor can be isolated from human placental extracts prepared using octylglucoside. The extracts can be passed over an affinity column composed of anti-αVβ3 monoclonal antibody (LM609) to Affigel. The column can subsequently be washed extensively at pH 7 and pH 4.5 followed by elution at pH 3. The resulting sample can be concentrated by wheat germ agglutinin chromatography and can be identified by the presence of two bands on SDS gel and confirned as αVβ3 by western blotting. The receptor can also be prepared in a soluble recombinant form using baculovirus expression as described (Mehta et al., Biochem. J. 330(pt. 2): 861-869 (1998)).

Affinity purified protein can be diluted at different levels and plated to 96 well plates. ELISA can be performed using fixed concentration of biotinylated vitronectin (approximately 80 nM/well). This receptor preparation is confirmed to contain the αVβ3 with no detectable levels of αVβ5 by gel (αVβ3) and by testing the effects of blocking antibodies for the αVβ3 or αVβ5 in the ELISA.

A submaximal concentration of biotinylated vitronectin can be selected based on a concentration response curve with a fixed concentration of receptor and variable concentrations of biotinylated vitronectin.

αVβ3 -Vitronectin Binding Assay

Integrin-ligand binding interactions can be measured as detailed previously (Mehta et al., supra). The purified receptor can be diluted with coating buffer (20 mM Tris HCl, 150 mM NaCl, 1.0 mM CaCl₂, 1.0 mM MgCl₂6H₂O, 10.0 μM MnCl₂.4H₂O) and coated (100 μL/well) on Costar (3590) high capacity binding plates overnight at 4° C. The coating solution is discarded and the plates washed once with blocking/binding buffer (B/B buffer, 50 mM Tris HCl, 100 mM NaCl, 1.0 mM CaCl₂, 1.0 mM MgCl₂.6H₂O, 10.0 μM MnCl₂.4H₂O). Receptor is then blocked (200 μL/well) with 3.5% BSA in B/B buffer for 2 hours at room temperature. After washing once with 1.0% BSA in B/B buffer, biotinylated vitronectin (100 μL) and either inhibitor (11 μL) or B/B buffer w/1.0% BSA (11 μL) is added to each well. The plates are incubated 2 hours at room temperature. The plates are washed twice with B/B buffer and incubated 1 hour at room temperature with anti-biotin alkaline phosphatase (100 μL/well) in B/B buffer containing 1.0% BSA. The plates are washed twice with B/B buffer and alkaline phosphatase substrate (100 μL) is added. Color is developed at room temperature. Color development is stopped by addition of 2N NaOH (25 μL/well) and absorbance is read at 405 nm. The IC₅₀ is the concentration of test substance needed to block 50% of the vitronectin binding to the receptor. A compound is considered to be active if it has an IC₅₀ value of less than or equal to about 10 μM in the αVβ3-Vitronectin Binding Assay. Compounds with an IC₅₀ less than 100 nM for the inhibition of vitronectin are generally desirable.

Integrin Cell-Based Adhesion Assays

In the adhesion assays, a 96 well plate are coated with the appropriate ligand (e.g., fibrinogen, vitronectin, fibronectin, thrombospondin, laminin, collagen, VCAM-1, ICAM-1, ICAM-2, Factor X, osteopontin, bone sialoprotein, or vWF) for the integrin to be tested and incubated overnight at 4° C. The following day, the cells are harvested, washed, and loaded with a fluorescent dye. Compounds and cells are added together and then are immediately added to the coated plate. After incubation, loose cells are removed from the plate, and the plate (with adherent cells) is counted on a fluorometer. The ability of test compounds to inhibit cell adhesion by 50% is given by the IC₅₀ value and represents a measure of potency of inhibition of integrin mediated binding. Compounds are tested for their ability to block cell adhesion using integrin interaction assays specific for the integrin of interest.

Platelet Aggregation Assay

Venous blood is obtained from anesthetized mongrel dogs or from healthy human donors who are drug- and aspirin-free for at least two weeks prior to blood collection. Blood is collected into citrated Vacutainer tubes. The blood is centrifuged for 15 minutes at 150×g (850 RPM in a Sorvall RT6000 Tabletop Centrifuge with H-1000 B rotor) at room temperature, and platelet-rich plasma (PRP) is removed. The remaining blood is centrifuged for 15 minutes at 1500×g (26,780 RPM) at room temperature, and platelet-poor plasma (PPP) is removed. Samples are assayed on a PAP-4 Platelet Aggregation Profiler, using PPP as the blank (100% transmittance). 200 μL of PRP (5×10⁸ platelets/mL) are added to each micro test tube, and transmittance is set to zero percent. 20 μL of ADP (10 μM) is added to each tube, and the aggregation profiles are plotted (percent transmittance versus time). Test agent (20 μL) is added at different concentrations prior to the addition of the platelet agonist. Results are expressed as percent inhibition of agonist-induced platelet aggregation.

Human Aortic Smooth Muscle Cell Migration Assay

A method for assessing αVβ3-mediated smooth muscle cell migration and agents which inhibit αVβ3-mediated smooth muscle cell migration is described in Liaw et al., J. Clin. Invest. (1995) 95:713-724).

In Vivo Angiogenesis Model

A quantitative method for assessing angiogenesis and antiangiogenic agents is described in Passaniti et al., Laboratory Investigation (1992) 67:519-528.

Pig Restenosis Model

A method for assessing restenosis and agents which inhibit restenosis is described in Schwartz et al., J. Am. College of Cardiology (1992) 19:267-274.

Mouse Retinopathy Model

A method for assessing retinopathy and agents which inhibit retinopathy is described in Smith et al., Invest. Ophthal. & Visual Science (1994) 35:101-111.

A number of embodiments of the invention have been described. Nevertheless, it will be understood that various modifications may be made without departing from the spirit and scope of the invention. Accordingly, other embodiments are within the scope of the following claims.

1. A method for determining whether a test compound is a potential modulator of αVβ3 integrin, the method comprising:
a) providing a computer model of the three-dimensional structure comprising a binding site of αVβ3 integrin defined by the atomic coordinates of αVβ3 integrin amino acids αV:Ala215, αV:Asp218; αV:Asp150; αV:Tyr178; β3:Tyr122; β3:Arg214; β3:Asn215; and β3:Arg216 according to Table 2;
b) providing a computer model of the three dimensional structure of a test compound;
c) computationally performing a fitting operation between the computer model of the binding site and the computer model of the test compound; and
d) evaluating the results of the fitting operation to evaluate the ability of the test compound to bind αVβ3 integrin;
wherein a test compound having the ability to bind αVβ3 integrin is a potential modulator of αVβ3 integrin.

2. The method of claim 1, wherein the computer model of the three-dimensional structure of a test compound is from a database of compounds of known structure.

3. The method of claim 1, wherein the three-dimensional structure of the binding site of αVβ3 integrin is defined by the atomic coordinates of αVβ3 integrin amino acids according to Table 2.

4. The method of claim 1, wherein the fitting operation comprises determining an energy minima configuration of computer model of the three-dimensional structure of the test compound in the computer model of the three-dimensional structure of αVβ3 integrin.

5. A method for determining whether a test compound is a potential modulator of αVβ3 integrin, the method comprising:
a) providing a computer model of the three-dimensional structure comprising a binding site of αVβ3 integrin defined by the atomic coordinates of αVβ3 integrin amino acids αV:Ala215, αV:Asp218; αV:Asp150; αV:Tyr178; β3:Asp119; β3:Ser121; β3:Tyr122; β3:Ser123; β3:Asp126; β3:Asp127; β3:Asp158; β3:Arg214; β3:Asn215; β3:Arg216; β3:Asp217; β3:Ala218; β3:Pro219; β3:Glu220; and β3:Asp251 according to Table 2;
b) providing a computer model of the three dimensional structure of a test compound;
c) computationally performing a fitting operation between the computer model of the binding site and the computer model of the test compound; and
d) evaluating the results of the fitting operation to evaluate the ability of the test compound to bind αVβ3 integrin;
wherein a test compound having the ability to bind αVβ3 integrin is a potential modulator of αVβ3 integrin.

6. The method of claim 5, wherein the computer model of the three-dimensional structure of a binding site of αVβ3 is further defined by the inclusion of the atomic coordinates of one or more divalent cations according to Table 2.

7. The method of claim 5, wherein the computer model of the three-dimensional structure of a test compound is from a database of compounds of known structure.

8. The method of claim 5, wherein the three-dimensional structure of the binding site of αVβ3 integrin is defined by the atomic coordinates of αVβ3 integrin amino acids according to Table 2.

9. The method of claim 5, wherein the fitting operation comprises determining an energy minima configuration of computer model of the three-dimensional structure of the test compound in the computer model of the three-dimensional structure of αVβ3.

10. A method for determining whether a test compound is a potential modulator of αVβ3 integrin, the method comprising:
a) providing a computer model of the three-dimensional structure comprising a binding site of αVβ3 defined by the atomic coordinates of αVβ3 amino acids αV:Ala215, αV:Asp218; αV:Asp150; αV:Tyr178; β3:Asp119; β3:Ser121; β3:Tyr122; β3:Ser123; β3:Asp126; β3:Asp127; β3:Asp158; β3:Arg214; β3:Asn215; β3:Arg216; β3:Asp217; β3:Ala218; β3:Pro219; β3:Glu220; and β3:Asp251 according to Table 2;
b) providing a computer model of the three dimensional structure of a test compound;
c) computationally performing a fitting operation between the computer model of the binding site and the computer model of the test compound;
d) evaluating the results of the fitting operation to evaluate the ability of the test compound to bind αVβ3 integrin;
e) electing a test compound having the ability to bind αVβ3 integrin as a potential modulator of αVβ3 integrin;
f) obtaining or synthesizing the potential modulator; and
g) evaluating the ability of the potential modulator to modulate the activity of αVβ3 integrin.

11. The method of claim 5, wherein the computer model of the three-dimensional structure of a binding site of αVβ3 integrin is further defined by the inclusion of the atomic coordinates of one or more divalent cations according to Table 2.

12. The method of claim 10, wherein the fitting operation comprises determining an energy minima configuration of computer model of the three-dimensional structure of the test compound in the computer model of the three-dimensional structure of αVβ3 integrin.

13. The method of claim 10, wherein the evaluating comprises determining the binding affinity of the test compound for αVβ3 integrin.

14. A method for determining whether a test compound is a potential modulator of αVβ3 integrin, the method comprising:
a) providing a computer model of the three-dimensional structure of cyclo(RGDf-N-Me-V) according to Table 1 or Table 2;
b) providing a computer model of the three dimensional structure of a test compound;
c) computationally comparing the computer model of the binding site and the computer model of the test compound; and
d) evaluating the results of the comparison to evaluate the ability of the test compound to bind αVβ3 integrin;
wherein a test compound having a structure similar to cyclo(RGDf-N-Me-V) is a potential modulator of αVβ3 integrin.

15. A method for determining whether a test compound is a potential modulator of αVβ3 integrin, the method comprising:
a) providing a computer model of the three-dimensional structure comprising an active site groove of αVβ3 integrin defined by the atomic coordinates of αVβ3 integrin amino acids αV:Ala215, αV:Asp218; αV:Asp150; αV:Tyr178; β3:Tyr122; β3:Arg214; β3:Asn215; and β3:Arg216 according to Table 2;
b) providing a computer model of the three dimensional structure of a test compound;
c) computationally performing a fitting operation between the computer model of the active site groove and the computer model of the test compound; and
d) evaluating the results of the fitting operation to evaluate the ability of the test compound to interact with the active site groove of αVβ3 integrin;
wherein a test compound having the ability to interact with the active site groove of αVβ3 integrin is a potential modulator of αVβ3 integrin.

16. The method of claim 15, wherein the computer model of the three-dimensional structure of a test compound is from a database of compounds of known structure.

17. The method of claim 15, wherein the three-dimensional structure of the active site groove of αVβ3 integrin is defined by the atomic coordinates of αVβ3 integrin amino acids according to Table 2.

18. The method of claim 15, wherein the fitting operation comprises determining an energy minima configuration of computer model of the three-dimensional structure of the test compound in the computer model of the three-dimensional structure of αVβ3 integrin.

19. The method according to claim 15 wherein the active site groove is formed by the D3-A3, A3-B3, and D4-A4 loops (as shown in FIG. 2A).

20. A method for evaluating the potential of a chemical entity to associate with:
a) a molecule or molecular complex comprising a binding pocket defined by the atomic coordinates of αVβ3 integrin amino acids αV:Ala215, αV:Asp218; αV:Asp150; αV:Tyr178; β3:Tyr122; β3:Arg214; β3:Asn215; and β3:Arg216 according to Table 2, or
b) a homologue of the molecule or molecular complex, wherein the homologue comprises a binding pocket that has a root mean square deviation from the backbone atoms of the amino acids of not more than 1.5 Å, the method comprising:
i) employing computational means to perform a fitting operation between the chemical entity and a binding pocket defined by the structure coordinates of αVβ3 integrin amino acids αV:Ala215, αV:Asp218; αV:Asp150; αV:Tyr178; β3:Tyr122; β3:Arg214; β3:Asn215; and β3:Arg216 according to Table 2 ±a root mean square deviation from the backbone of the amino acids of not more than 1.5 Å; and
ii) analyzing the results of the fitting operation to quantify the association between the chemical entity and the binding pocket.

21. The method of claim 20, wherein the method evaluates the potential of a chemical entity to associate with:
a) a molecule or molecular complex comprising a binding pocket defined by the atomic coordinates of αVβ3 integrin amino acids αV:Ala215, αV:Asp218; αV:Asp150; αV:Tyr178; β3:Asp119; β3:Ser121; β3:Tyr122; β3:Ser123; β3:Asp126; β3:Asp127; β3:Asp158; β3:Arg214; β3:Asn215; β3:Arg216; β3:Asp217; β3:Ala218; β3:Pro219; β3:Glu220; and β3:Asp251 according to Table 2, or
b) a homologue of the molecule or molecular complex, wherein the homologue comprises a binding pocket that has a root mean square deviation from the backbone atoms of the amino acids of not more than 1.5 Å.

22. A method for identifying a potential modulator of molecule or molecular complex comprising αVβ3 integrin-like binding pocket, the method comprising:
a) using the atomic coordinates of αVβ3 integrin amino acids αV:Ala215, αV:Asp218; αV:Asp150; αV:Tyr178; β3:Tyr122; β3:Arg214; β3:Asn215; and β3:Arg216 according to Table 2 ±a root mean square deviation from the backbone atoms of the amino acids of not more than 1.5 Å, to generate a three-dimensional structural model of a molecule or molecular complex comprising an αVβ3 integrin-like binding pocket;
b) employing the three-dimensional structural model to design or select said potential modulator;
c) synthesizing the potential modulator; and
d) contacting the potential modulator with the molecule or molecular complex to determine the ability of the potential modulator to interact with the molecule or molecular complex.

23. A method for evaluating the potential of a chemical entity to associate with a molecule or molecular complex comprising a ligand binding pocket of an αVβ3 extracellular domain, the method comprising:
a) employing computational means to perform a fitting operation between the chemical entity and a binding pocket defined by the structural coordinates described in Table 1 or Table 2; and
b) analyzing the results of said fitting operation to quantify the association between the chemical entity and the binding pocket.

24. A computer for producing a three-dimensional representation of a molecule or molecular complex, wherein said molecule or molecular complex comprises a binding pocket defined by structure coordinates of Table 1 or Table 2 wherein said computer comprises:
a) a machine-readable data storage medium comprising a data storage material encoded with machine-readable data, wherein said data comprises the structure coordinates of Table 1 or Table 2 amino acids of the αVβ3 extracellular domain;
b) a working memory for storing instructions for processing said machine-readable data;
c) a central-processing unit coupled to said working memory and to said machine-readable data storage medium for processing said machine readable data into said three-dimensional representation; and
d) a display coupled to said central-processing unit for displaying said three-dimensional representation.

25. A crystal comprising an integrin αVβ3 extracellular domain complexed with a cyclic RGD peptide.

26. The crystal of claim 25 wherein the cyclic RGD peptide ligand comprises an amino acid sequence comprising Arg-Gly-Asp-(D-Phe)-(N-methyl-Val).

27. The crystal of claim 25 wherein the cyclic RGD peptide ligand comprises an amino acid sequence comprising Arg-Gly-Asp-(D-Phe)-(N-methyl-Val) in the presence of a metal.

28. The method of claim 1 wherein the test compound is: (i) computationally assembled molecular fragments; (ii) selected from a small molecule database; or (iii) computationally created by de novo ligand design.


SEQUENCE LISTING (12 sequences)

SEQ ID NO: 1 - protein, 5 aa, Artificial
  synthetic cyclo(RGDf-N-Me-V) cyclic pentapeptide ligand
RGDFV

SEQ ID NO: 2 - protein, 957 aa, Homo sapiens
FNLDVDSPAEYSGPEGSYFGFAVDFFVPSASSRMFLLVGAPKANTTQPGIVEGGQVLKCDWSSTRRCQPIEFDATGNRDYAKDDPLEFKSHQWFGASVRSKQDKILACAPLYHWRTEMKQEREPVGTCFLQDGTKTVEYAPCRSQDIDADGQGFCQGGFSIDFTKADRVLLGGPGSFYWQGQLISDQVAEIVSKYDPNVYSIKYNNQLATRTAQAIFDDSYLGYSVAVGDFNGDGIDDFVSGVPRAARTLGMVYIYDGKNMSSLYNFTGEQMAAYFGFSVAATDINGDDYADVFIGAPLFMDRGSDGKLQEVGQVSVSLQRASGDFQTTKLNGFEVFARFGSAIAPLGDLDQDGFNDIAIAAPYGGEDKKGIVYIFNGRSTGLNAVPSQILEGQWAARSMPPSFGYSMKGATDIDKNGYPDLIVGAFGVDRAILYRARPVITVNAGLEVYPSILNQDNKTCSLPGTALKVSCFNVRFCLKADGKGVLPRKLNFQVELLLDKLKQKGAIRRALFLYSRSPSHSKNMTISRGGLMQCEELIAYLRDESEFRDKLTPITIFMEYRLDYRTAADTTGLQPILNQFTPANISRQAHILLDCGEDNVCKPKLEVSVDSDQKKIYIGDDNPLTLIVKAQNQGEGAYEAELIVSIPLQADFIGVVRNNEALARLSCAFKTENQTRQVVCDLGNPMKAGTQLLAGLRFSVHQQSEMDTSVKFDLQIQSSNLFDKVSPVVSHKVDLAVLAAVEIRGVSSPDHVFLPIPNWEHKENPETEEDVGPVVQHIYELRNNGPSSFSKAMLHLQWPYKYNNNTLLYILHYDIDGPMNCTSDMEINPLRIKISSLQTTEKNDTVAGQGERDHLITKRDLALSEGDIHTLGCGVAQCLKIVCQVGRLDRGKSAILYVKSLLWTETFMNKENQNHSYSLKSSASFNVIEFPYKNLPIEDITNSTLVTTNVTWGIQP

SEQ ID NO: 3 - protein, 692 aa, Homo sapiens
GPNICTTRGVSSCQQCLAVSPMCAWCSDEALPLGSPRCDLKENLLKDNCAPESIEFPVSEARVLEDRPLSDKGSGDSSQVTQVSPQRIALRLRPDDSKNFSIQVRQVEDYPVDIYYLMDLSYSMKDDLWSIQNLGTKLATQMRKLTSNLRIGFGAFVDKPVSPYMYISPPEALENPCYDMKTTCLPMFGYKHVLTLTDQVTRFNEEVKKQSVSRNRDAPEGGFDAIMQATVCDEKIGWRNDASHLLVFTTDAKTHIALDGRLAGIVQPNDGQCHVGSDNHYSASTTMDYPSLGLMTEKLSQKNINLIFAVTENVVNLYQNYSELIPGTTVGVLSMDSSNVLQLIVDAYGKIRSKVELEVRDLPEELSLSFNATCLNNEVIPGLKSCMGLKIGDTVSFSIEAKVRGCPQEKEKSFTIKPVGFKDSLIVQVTFDCDCACQAQAEPNSHRCNNGNGTFECGVCRCGPGWLGSQCECSEEDYRPSQQDECSPREGQPVCSQRGECLCGQCVCHSSDFGKITGKYCECDDFSCVRYKGEMCSGHGQCSCGDCLCDSDWTGYYCNCTTRTDTCMSSNGLLCSGRGKCECGSCVCIQPGSYGDTCEKCPTCPDACTFKKECVECKKFDREPYMTENTCNRYCRDEIESVKELKDTGKDAVNCTYKNEDDCVVRFQYYEDSSGKSILYVVEEPECPKGPD

SEQ ID NO: 4 - protein, 43 aa, Homo sapiens
FAALGSIQKQLQEKIYAVEGTQSRASSSFQHEMSQEGFSTALT

SEQ ID NO: 5 - protein, 43 aa, Homo sapiens
FDALKDIQNQLKEKIFAIEGTETTSSSSFELEMAQEGFSAVFT

SEQ ID NO: 6 - protein, 43 aa, Homo sapiens
FEALKTIQNQLREKIFAIEGTQTGSSSSFEHEMSQEGFSAAIT

SEQ ID NO: 7 - protein, 43 aa, Homo sapiens
FEKLKDLFTELQKKIYVIEGTSKQDLTSFNMELSSSGISADLS

SEQ ID NO: 8 - protein, 42 aa, Homo sapiens
EAALKDIVDALGDRIFSLEGTNKNETSFGLEMSQTGFSSHVV

SEQ ID NO: 9 - protein, 43 aa, Homo sapiens
EAALTDIVDALGDRIFGLEGSHAENESSFGLEMSQIGFSTHRL

SEQ ID NO: 10 - protein, 43 aa, Homo sapiens
ELALVTIVKTLGERIFALEATADQSAASFEMEMSQTGFSAHYS

SEQ ID NO: 11 - protein, 42 aa, Homo sapiens
EAALLEKAGTLGEQIFSIEGTVQGGDNFQMEMSQVGFSADYS

SEQ ID NO: 12 - protein, 40 aa, Homo sapiens
YMALDGLLSKLRYNIISMEGTVGDALHYQLAQIGFSAQIL